(19) United States
(12) Patent Application Publication
(10) Pub. No.: US 2008/0218503 A1
(43) Pub. Date: Sep. 11, 2008

(54) Power supply, plasma display including power supply, and method of driving plasma display

(76) Inventor: Il-Woon Lee, Suwon-si (KR)

Correspondence Address: ROBERT E. BUSHNELL, 1522 K STREET NW, SUITE 300, WASHINGTON, DC, 20005-1202, US

(21) Appl. No.: 12/002,754

(22) Filed: Dec. 19, 2007

(30) Foreign Application Priority Data
Mar. 8, 2007 (KR) 10-2007-0022929

(51) Int. Cl. G06F 3/038; G05F 1/70

(52) U.S. Cl. 345/211; 323/205

(57) ABSTRACT

In a power supply, a plasma display including the power supply, and a method of driving the plasma display, a DC voltage output by a power factor correction unit is converted into a voltage Vs supplied to a sustain or scan electrode during a sustain period, and the voltage Vs is converted into a voltage Va supplied to an address electrode during an address period. The voltage Vs is a less than the DC voltage of the power factor correction unit, and components with a low voltage rating can be used for the Va voltage generator.

### CLAIM OF PRIORITY

This application makes reference to, incorporates the same herein, and claims all benefits accruing under 35 U.S.C. §119 from an application for POWER SUPPLY APPARATUS PLASMA DISPLAY INCLUDING POWER SUPPLY APPARATUS AND DRIVING METHOD THEREOF earlier filed in the Korean Intellectual Property Office on 8 Mar. 2007 and there duly assigned Serial No. 10-2007-0022929.

### BACKGROUND OF THE INVENTION

1. Field of the Invention

The present invention relates to a power supply, a plasma display including the power supply, and a method of driving the plasma display.

2. Description of the Related Art

A plasma display is a flat panel display for displaying characters or images by using plasma generated by gas discharge, in which several tens to several millions of pixels are arranged in a matrix format according to the device size. A power supply generates a plurality of voltages and supplies the voltages to electrodes configuring a plasma display panel (PDP). The plasma display panel (PDP) displays screens with discharge provided between electrodes by the voltages.

FIG. 1 is a view of a general power supply.

As shown in FIG. 1, the power supply includes an AC filter 10, a power factor correction unit 20, a voltage generator unit 30, and a standby voltage generator unit 40.

The AC filter 10 filters the external AC voltage (AC) to remove noise therefrom. The power factor correction unit 20 receives the AC voltage (AC) from the AC filter, corrects the power factor, and outputs the corrected power factor as a DC voltage (DC). The voltage generator unit 30 includes a Vs voltage generator 31, a Va voltage generator 32, and a Vm voltage generator 33, which are a plurality of DC-DC converters. The Vs voltage generator 31, the Va voltage generator 32, and the Vm voltage generator 33 respectively receive a DC voltage from the power factor correction unit 20 and generate DC voltages (Vs, Va, 15V, and 5V) used for the plasma display. The standby voltage generator unit 40 receives an AC voltage (AC) from the AC filter 10 and generates standby voltages 5V and 9V.

In this instance, the voltage (Vp) output by the power factor correction unit 20 is about 400V. Hence, the Vs voltage generator 31 and the Va voltage generator 32 use components with high voltage ratings so as to generate the voltages Vs and Va by DC-DC converting the high voltage input by the power factor correction unit 20. Accordingly, the cost of components becomes expensive because of the use of components with high voltage ratings.

### SUMMARY OF THE INVENTION

The present invention has been made in an effort to provide a power supply for reducing the cost of a plasma display, a plasma display including the power supply, and a method of driving the plasma display.

An exemplary embodiment of the present invention provides a power supply for supplying a plurality of voltages including a power factor correction unit and a voltage generator unit. The power factor correction unit corrects a power factor of an input AC voltage and outputs a DC voltage. The voltage generator unit includes a first voltage generator having an input terminal connected to an output terminal of the power factor correction unit and converting the DC voltage into a first voltage that is less than the DC voltage, and a second voltage generator having an input terminal connected to an output terminal of the first voltage generator and converting the first voltage into a second voltage that is less than the first voltage.

Another embodiment of the present invention provides a plasma display including a Plasma Display Panel (PDP), a driver, and a power unit. The PDP includes a first electrode, a second electrode, and a third electrode crossing the first and second electrodes. The driver drives the PDP. The power unit supplies a plurality of voltages to the driver. The power unit includes a power factor correction unit, a first voltage generator, and a second voltage generator. The power factor correction unit corrects a power factor of the input AC voltage and outputs a DC voltage. The first voltage generator has an input terminal connected to an output terminal of the power factor correction unit and converts the DC voltage into a first voltage that is supplied to one of the first and second electrodes in the sustain period. The second voltage generator has an input terminal connected to an output terminal of the first voltage generator and converts the first voltage into a second voltage that is less than the first voltage that is supplied to the third electrode in the address period.

Yet another embodiment of the present invention provides a method of driving a plasma display including a power factor correction unit for correcting a power factor of an input AC voltage and outputting a DC voltage, and a voltage generator unit for converting the DC voltage into a plurality of voltages for driving the plasma display. In the method, the DC voltage is converted into a first voltage that is less than the DC voltage, the first voltage is converted into a second voltage that is less than the first voltage, and the first voltage and the second voltage are supplied to the plasma display.

### BRIEF DESCRIPTION OF THE DRAWINGS

A more complete appreciation of the present invention, and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a view of a power supply.

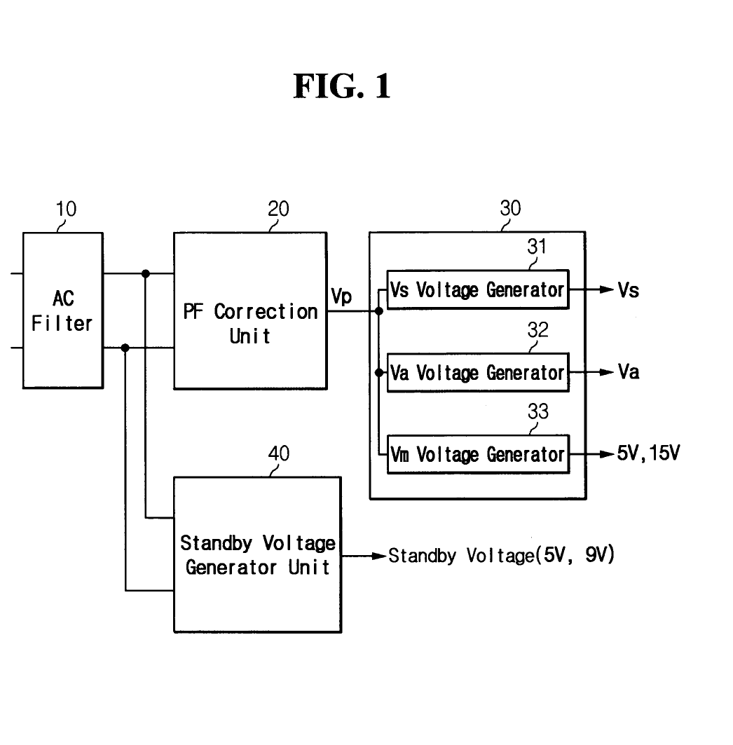

FIG. 2 is a top plan view of a plasma display according to an exemplary embodiment of the present invention.

FIG. 3 is a view of a plasma display driving method according to an exemplary embodiment of the present invention.

FIG. 4 is a view of an internal configuration of a power supply according to an exemplary embodiment of the present invention.

FIG. 5 is a view of a voltage generator unit according to a first exemplary embodiment of the present invention.

FIG. 6 is a view of a voltage generator unit according to a second exemplary embodiment of the present invention.

FIG. 7 is a view of a voltage generator unit according to a third exemplary embodiment of the present invention.

### DETAILED DESCRIPTION OF THE INVENTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification. A connection of a first unit to a second unit includes direct connection thereof and electrical connection of a first unit to a second unit with a component therebetween. Throughout this specification and the claims which follow, unless explicitly described to the contrary, the word “comprising” or variations such as “comprises” will be understood to imply the inclusion of stated elements but not the exclusion of any other elements.

Wall charges in the embodiments of the present invention represent charges formed and accumulated on a wall (e.g., a dielectric layer) close to an electrode of a discharge cell. Although the wall charges do not actually touch the electrodes, the wall charges will be described as being “formed” or “accumulated” on the electrode. Furthermore, a wall voltage represents a potential difference formed on the wall of the discharge cell by the wall charges.

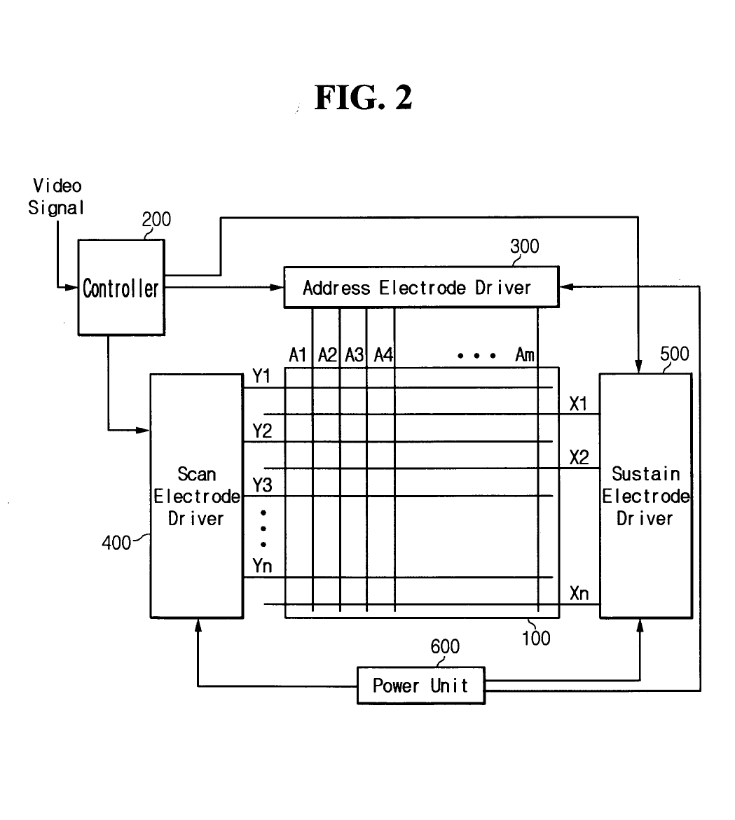

FIG. 2 is a top plan view of a plasma display according to an exemplary embodiment of the present invention.

As shown in FIG. 2, the plasma display includes a Plasma Display Panel (PDP) 100, a controller 200, an address electrode driver 300, a scan electrode driver 400, a sustain electrode driver 500, and a power unit 600.

The PDP 100 includes a plurality of address electrodes A1-Am in the column direction and a plurality of sustain electrodes X1-Xn and scan electrodes Y1-Yn in pairs in the row direction. The sustain electrodes X1-Xn are formed to correspond to the scan electrodes Y1-Yn, and the sustain electrodes X1-Xn and the scan electrodes Y1-Yn perform a display operation for displaying images during the sustain period. The address electrodes A1-Am are arranged to cross the sustain electrodes X1-Xn and the scan electrodes Y1-Yn. In this instance, a discharge space at a crossing part of the address electrode A1-Am, the scan electrode Y1-Yn, and the sustain electrode X1-Xn forms a cell. The above-noted configuration of the plasma display panel (PDP) 100 is an example, and other types of panels to which a driving method to be described is applicable can be applied to the embodiments of the present invention.

The controller 200 receives an external video signal to output an address electrode drive control signal, a sustain electrode drive control signal, and a scan electrode drive control signal. The controller 200 divides a frame into a plurality of subfields and drives the subfields. Each subfield has a reset period, an address period, and a sustain period.

The address driver 300 receives an address electrode drive control signal from the controller 200 and supplies a display data signal for selecting a discharge cell to be displayed to the respective address electrodes.

The scan electrode driver 400 receives a scan electrode drive control signal from the controller 200 and supplies a driving voltage to the scan electrode.

The sustain electrode driver 500 receives a sustain electrode drive control signal from the controller 200 and supplies a driving voltage to the sustain electrode.

The power unit 600 generates a predetermined voltage to the respective drivers 300, 400, and 500 for driving the PDP 100.

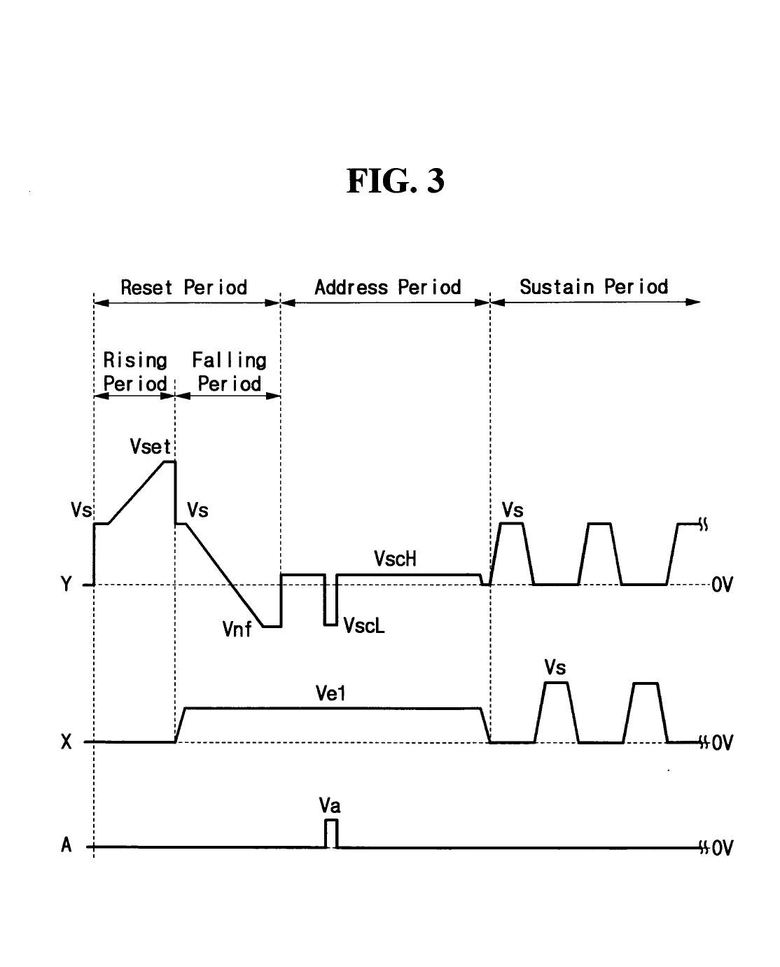

FIG. 3 is a view of a plasma display driving method according to an exemplary embodiment of the present invention.

For better understanding and ease of description, a driving waveform supplied to the address electrode (A electrode), the sustain electrode (X electrode), and the scan electrode (Y electrode) forming a cell is described below.

As shown in FIG. 3, in the rising period of the reset period, the voltages at the X electrode and the A electrode are maintained at the reference voltage (the reference voltage is assumed to be the ground voltage 0V in FIG. 2), and the voltage at the Y electrode is gradually increased from the voltage Vs to the voltage Vset. While the voltage at the Y electrode is increased, a weak discharge is generated between the Y electrode and the X electrode and between the Y electrode and the A electrode so that (−) wall charges are formed on the Y electrode and (+) wall charges are formed on the X electrode and the A electrode.

In the falling period of the reset period, the voltage at the Y electrode is gradually decreased from the voltage Vs to the voltage Vnf while the voltages at the A electrode and the X electrode are maintained at the reference voltage and the voltage Ve, respectively. While the voltage at the Y electrode is decreased, a weak discharge is generated between the Y electrode and the X electrode and between the Y electrode and the A electrode, and hence the (−) wall charges formed at the Y electrode and the (+) wall charges formed at the X electrode and the A electrode are erased. In general, the voltage (Vnf−Ve) is set to be near the discharge firing voltage (Vfxy) between the Y electrode and the X electrode. The wall voltage between the Y electrode and the X electrode almost reaches 0V to thus prevent the cell that is not address discharged in the address period from being misfired in the sustain period.

In the address period, a scan pulse sequentially having the voltage VscL is supplied to a plurality of Y electrodes while the voltage Ve is supplied to the X electrode so as to select the discharge cell to be turned on. In this instance, the voltage Va is supplied to the A electrode passing through the discharge cell to emit light from among the discharge cells formed by the Y electrode to which the voltage VscL is supplied and the X electrode. An address discharge is generated between the A electrode to which the voltage Va is supplied and the Y electrode to which the voltage VscL is supplied and between the Y electrode to which the voltage VscL is supplied and the X electrode to which the voltage Ve is supplied. Accordingly, the (+) wall charges are formed at the Y electrode, and the (−) wall charges are formed at the A electrode and the X electrode. The voltage VscH that is greater than the voltage VscL is supplied to the Y electrode to which no voltage VscL is supplied, and the reference voltage is supplied to the A electrode of the discharge cell that is not selected.

In order to perform the operation in the address period, the scan electrode driver 400 selects the Y electrode to which a scan pulse having the voltage VscL will be supplied from among the Y electrodes Y1-Yn. For example, the scan electrode driver 400 can select the Y electrodes in the order of vertical arrangement in the single driving. When one Y electrode is selected, the address electrode driver 300 selects a discharge cell to be turned on from among the discharge cells formed by the corresponding Y electrode. That is, the address electrode driver 300 selects the cell to which the address pulse with the voltage Va will be supplied from among the A electrodes.

In the sustain period, a sustain pulse having a high level voltage (voltage Vs in FIG. 3) and a low level voltage (0V in FIG. 3) is supplied in opposite phases to the Y electrode and the X 12 electrode. The voltage Vs is supplied to the Y electrode and 0V is supplied to the X electrode to generate a sustain discharge between the Y electrode and the X electrode, and (−) wall charges and (+) wall charges are formed at the Y electrode and the X electrode according to the sustain discharge. The process for supplying the sustain pulse to the Y electrode and the X electrode is repeated by a number of times corresponding to the weight displayed by the corresponding subfield. In general, the sustain pulse is a square wave having the sustain period of Vs.

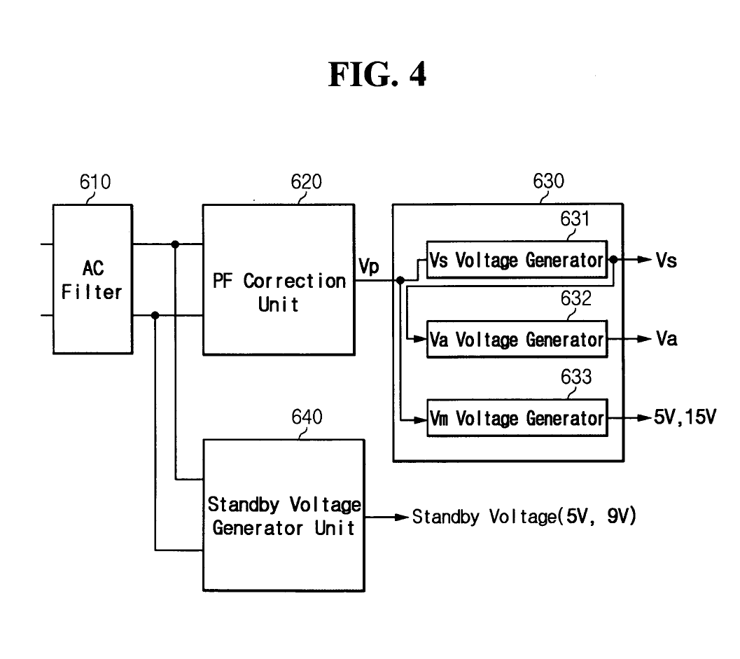

The voltages Vs, Va, VscH, and VscL supplied to the respective electrodes X, Y, and A are generated and supplied by the power unit 600. A configuration and operation of the power unit 600 is described below with reference to FIGS. 4 to 7.

FIG. 4 is a view of an internal configuration of a power unit 600 according to an exemplary embodiment of the present invention.

As shown in FIG. 4, the power unit 600 includes an AC filter 610, a power factor correction unit 620, a voltage generator unit 630, and a standby voltage generator unit 640.

The AC filter 610 filters the external AC voltage (AC) to remove noise therefrom. The power factor correction unit 620 receives the AC voltage (AC), corrects the power factor, and outputs the corrected power factor as a DC voltage Vp. The voltage generator unit 630 includes a plurality of voltage generators for receiving the DC voltage Vp from the power factor correction unit 620 and generating a plurality of DC voltages Vs, Va, 5V, and 15V, and the generated DC voltages Vs, Va, 5V, and 15V are supplied to the drivers 300, 400, and 500 for driving the plasma display (PDP). In this instance, the voltage Vs is supplied between the X electrodes or the Y electrodes during the sustain period. The voltage Va is supplied to the A electrode during the address period. The standby voltage generator unit 640 receives an AC voltage (AC) from the AC filter 610 and generates a standby voltage of the plasma display. Also, the standby voltage generator unit 640 generates and outputs a bias voltage (Vcc, not shown) used for the operation of the power factor correction unit 620 and the voltage generator unit 630. In this instance, the bias voltage (Vcc) biases an integrated circuit (IC, not shown) used to control the switch by the power factor correction unit 620 and the voltage generator unit 630.

As shown in FIG. 4, the voltage generator unit 630 includes a Vs voltage generator 631, a Va voltage generator 632, and a Vm voltage generator 633. In this instance, the voltage generators 631, 632, and 633 include DC-DC converters for converting the input voltage into DC voltages Vs, Va, 5V, and 15V. The Vs voltage generator 631 connected to an output terminal of the power factor correction unit 620 converts the DC voltage Vp output by the power factor correction unit 620 into the voltage Vs. The Va voltage generator 632 connected to an output terminal of the Vs voltage generator 631 converts the output voltage Vs of the Vs voltage generator 631 into the voltage Va. The Vm voltage generator 633 connected to an output terminal of the power factor correction unit 620 converts the DC voltage Vp output by the power factor correction unit 620 into the voltage Vm. In this instance, the Vm voltage generator 633 generates a voltage other than the voltage Vs and the voltage Va, and it may generate the voltage VscH or the voltage VscL.

In this instance, the DC voltage Vp output by the power factor correction unit 620 is a high voltage, and hence the Vs voltage generator 631 and the Vm voltage generator 633 must use components with high voltage ratings. In general, components with high voltage ratings are expensive. In this instance, the voltage Vs is relatively less than the output voltage Vp of the power factor correction unit 620. Therefore, the Va voltage generator 632 can use components with lower voltage ratings compared to the Vs voltage generator 631 or the Vm voltage generator 633. In general, components with lower voltage ratings are inexpensive.

FIG. 4 is a view of that the voltage generator unit 630 includes three voltage generators. However, when the voltage generator unit 630 is used for another display or a home appliance, the voltage generator unit 630 can additionally include a Vx voltage generator for generating another DC voltage Vx.

The power factor correction unit 620, the voltage generator unit 630, and the standby voltage generator unit 640 include a switch and pulse width modulation integrated circuit (PWM IC, referred to as a switch controller hereinafter) to generate and supply a predetermined voltage.

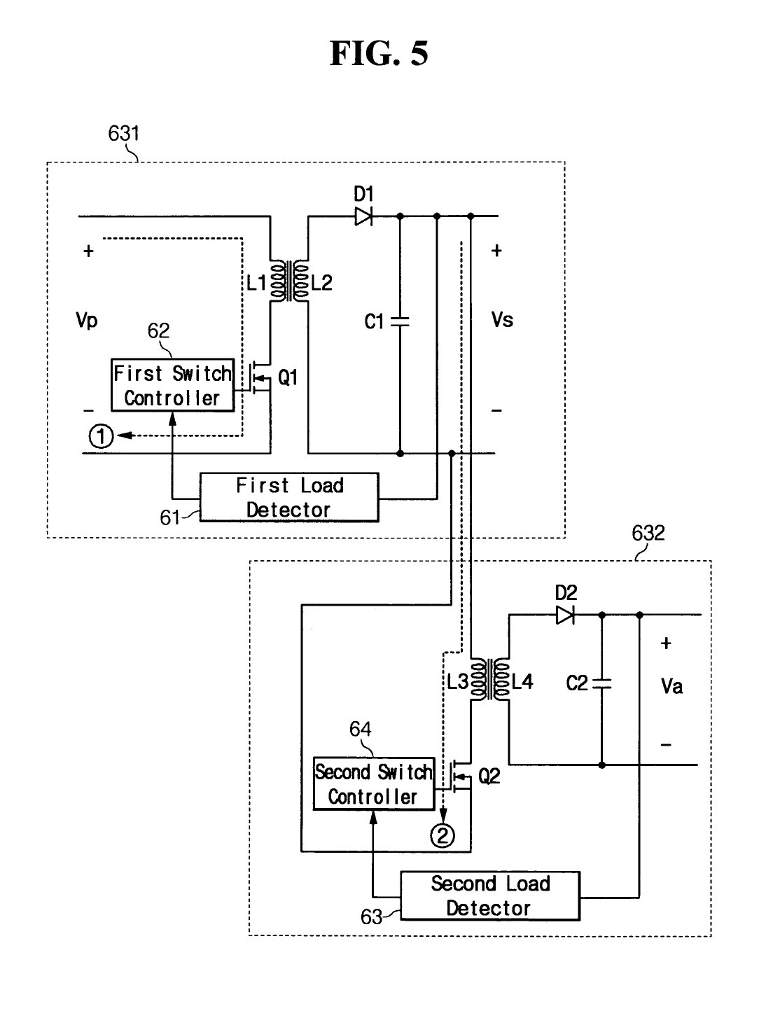

FIGS. 5 to 7 are views of a voltage generator unit according to an exemplary embodiment of the present invention, including a Vs voltage generator and a Va voltage generator. In this instance, the Vs voltage generator 631 and the Va voltage generator 632 are DC-DC converters for converting an input DC voltage into a desired DC voltage.

FIG. 5 is a view of a voltage generator unit according to a first exemplary embodiment of the present invention.

The Va voltage generator 632 receives an output voltage Vs from the Vs voltage generator 631, and DC-DC converts the output voltage Vs into a voltage Va.

As shown in FIG. 5, the Vs voltage generator 631 of the voltage generator unit 630 includes a transformer Tx (L1 and L2), a switch Q1, a diode D1, a capacitor C1, a first load detector 61, and a first switch controller 62.

A first terminal of the primary coil L1 of the transformer is connected to an output terminal of the power factor correction unit 620 and a second terminal thereof is connected to a drain terminal of the switch Q1. A source terminal of the switch Q1 is grounded and a gate terminal thereof is connected to an output terminal of the first switch controller 62. A first terminal of the secondary coil L2 of the transformer is connected to an anode of the diode D1. A first terminal of the capacitor C1 is connected to a cathode of the diode D1 and a second terminal thereof is grounded. The first load detector 61 is connected to an output terminal of the Vs voltage generator 631 and transmits information corresponding to the voltage Vs to the first switch controller 62.

When the switch Q1 is turned on, the output voltage Vp of the power factor correction unit 620 is supplied to the Vs voltage generator 631, and a current path is formed as shown by (X of FIG. 5. According to the path (D, the output voltage Vp of the power factor correction unit 620 is supplied to the primary coil L1 of the transformer, and the voltage is supplied to the secondary coil L2 depending on the turn ratio N. The voltage supplied to the secondary coil L2 is charged in the capacitor C1 through the diode D1. That is, the output voltage Vs is determined by the turn ratio of the transformer and the on/off time (duty cycle) of the switch Q1.

The first load detector 61 detects an output voltage of the output terminal of the Vs voltage generator 631 and outputs it to the first switch controller 62. The first switch controller 62 compares a first output voltage input by the first load detector 61 and a first reference voltage. When the first output voltage is greater than the first reference voltage, the first switch controller 62 increases the on time of the switch Q1. The time in which the current is supplied to the capacitor C1 is increased to thus increase the output voltage Vs of the Vs voltage generator 632. On the contrary, when the first output voltage detected by the first load detector 61 is less than the first reference voltage, the first switch controller 62 reduces the on time of the switch Q1. The time in which the current is supplied to the capacitor C1 is decreased to thus reduce the output voltage Vs of the Vs voltage generator 631. Accordingly, the first switch controller 62 controls the on/off time (duty) of the switch Q1 according to the first output voltage of the output terminal to thus maintain the output voltage the Vs voltage generator 631 at the voltage Vs.

As shown in FIG. 5, the Va voltage generator 632 includes a transformer Tx: L3 and L4, a switch Q2, a diode D2, a capacitor C2, a second load detector 63, and a second switch controller 64. MOSFETs are used for the switches Q1 and Q2 in FIG. 5, but the present invention is not limited thereto, and other switches, such as bipolar transistors, are also usable.

The first terminal of the primary coil L3 of the transformer is connected to the first terminal of the capacitor C1 of the Vs voltage generator 631 and the second terminal thereof is connected to the drain terminal of the switch Q2. A source terminal of the switch Q2 is connected to the second terminal of the capacitor C1 of the Vs voltage generator 631 and a gate terminal thereof is connected to an output terminal of the second switch controller 64. A first terminal of the secondary coil L4 of the transformer is connected to an anode of the diode D2. A first terminal of the capacitor C2 is connected to a cathode of the diode D2 and a second terminal thereof is grounded. The second load detector 63 is connected to the output terminal of the Va voltage generator 632 and outputs information corresponding to the voltage Va to the second switch controller 64.

When the switch Q2 is turned on, the output voltage Vs of the Vs voltage generator 631 is input to the Va voltage generator 632 and a current path is formed as shown by \textcircled{2} of FIG. 5. According to the path \textcircled{2}, the output voltage Vs of the Vs voltage generator 631 is supplied to the primary coil L2 of the transformer and the voltage is supplied to the secondary coil L3 depending 14 on the turn ratio N. The voltage supplied to the secondary coil L2 is charged in the capacitor C3 through the diode D2, and the voltage supplied to the secondary coil L3 is charged in the capacitor C2 through the diode D2. In this instance, the voltage charged in the capacitor C2 is variable by the on/off time (duty) of the switch Q2, and hence the Va voltage is determined by the on/off operation 18 of the switch Q2.

The second load detector 63 detects the output voltage of the output terminal of the Va voltage generator 632 and outputs the output voltage to the second switch controller 64. The second switch controller 64 compares a second output voltage input by the second load detector 63 and a second reference voltage. When the second output voltage is greater than the second reference voltage, the second switch controller 64 increases the on time of the switch Q2. The time in which the current is supplied to the capacitor C2 is increased to increase the output voltage Va of the Va voltage generator 632. On the contrary, when the second output voltage detected by the second load detector 63 is less than the second reference voltage, the second switch controller 63 reduces the on time of the switch Q2. The time in which the current is supplied to the capacitor C2 is decreased to decrease the output voltage Va of the Va voltage generator 632

Accordingly, the second switch controller 64 controls the on/off time (duty cycle) of the switch Q2 according to the second output voltage of the output terminal to thus maintain the output voltage the Va voltage generator 632 at the constant voltage Va.

According to the first exemplary embodiment of the present invention, the Va voltage generator 632 can use components with lower voltage ratings by using the output voltage Vs of the Vs voltage generator 631 as an input voltage of the Va voltage generator 632, and also reduces the cost by using components with lower voltage ratings.

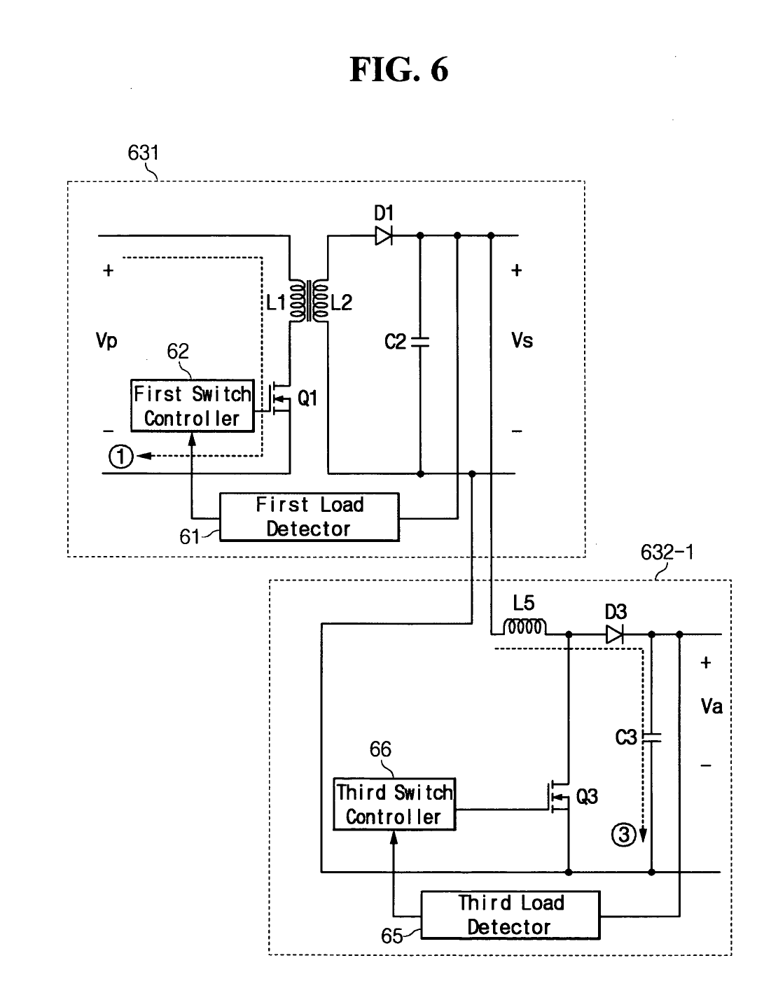

FIG. 6 is a view of a voltage generator unit according to a second exemplary embodiment of the present invention.

As shown in FIG. 6, the voltage generator unit according to the second exemplary embodiment of the present invention corresponds to the voltage generator unit according to the first exemplary embodiment of the present invention except for the configuration of the Va voltage generator.

The Va voltage generator 632-1 includes an inductor L5, a switch Q3, a diode D3, a capacitor C3, a third load detector 65, and a third switch controller 66.

A first terminal of the inductor L5 is connected to a first terminal of the capacitor C1 of the Vs voltage generator 631 and a second terminal thereof is connected to a drain terminal of the switch Q3. A source terminal of the switch Q3 is connected to a second terminal of the capacitor C1 of the Vs voltage generator 631 and a gate terminal thereof is connected to an output terminal of the third switch controller 66. An anode of the diode D3 is connected to a node of the inductor L5 and the switch Q3. A first terminal of the capacitor C3 is connected to a cathode of the diode D3 and a second terminal thereof is grounded. The third load detector 65 is connected to an output terminal of the Va voltage generator 632-1 and outputs information corresponding to the voltage Va to the third switch controller 66.

When the switch Q3 is turned off, the output voltage Vs of the Vs voltage generator 631 is input to the Va voltage generator 632-1, and the current path of \textcircled{3} is formed as shown in FIG. 6. The capacitor C3 is charged with the voltage according to the path \textcircled{3}. In this instance, since the voltage charged in the capacitor C3 is variable by the on/off time (duty cycle) of the switch Q3, the voltage Va is determined by the on/off operation of the switch Q3.

The third load detector 65 detects an output voltage of the output terminal of the Va voltage generator 632-1 and outputs the output voltage to the third switch controller 66. The third switch controller 66 compares a third output voltage input by the third load detector 65 and a third reference voltage. When the third output voltage is greater than the third reference voltage, the third switch controller 66 reduces the on time of the switch Q3. The time in which the current is supplied to the capacitor C3 is increased to thus increase the output voltage Va of the Va voltage generator 632-1. On the contrary, when the third output voltage detected by the third load detector 65 is less than the third reference voltage, the third switch controller 66 increases the on time of the switch Q3. The time in which the current is supplied to the capacitor C3 is decreased to thus decrease the output voltage Va of the Va voltage generator 632-1. Accordingly, the third switch controller 66 controls the on/off time (duty cycle) of the switch Q3 according to the third output voltage of the output terminal to thus maintain the output voltage of the Va voltage generator 632-1 at the constant voltage Va.

According to the second exemplary embodiment of the present invention, the Va voltage generator 632-1 can use components with lower voltage ratings by using the output voltage Vs of the Vs voltage generator 631 as an input voltage of the Va voltage generator 632-1, and also reduces the cost by using components with lower voltage ratings. Furthermore, the Va voltage generator 632-1 according to the second exemplary embodiment of the present invention can reduce the number of components by using the inductor L5 rather than the transformer Tx.

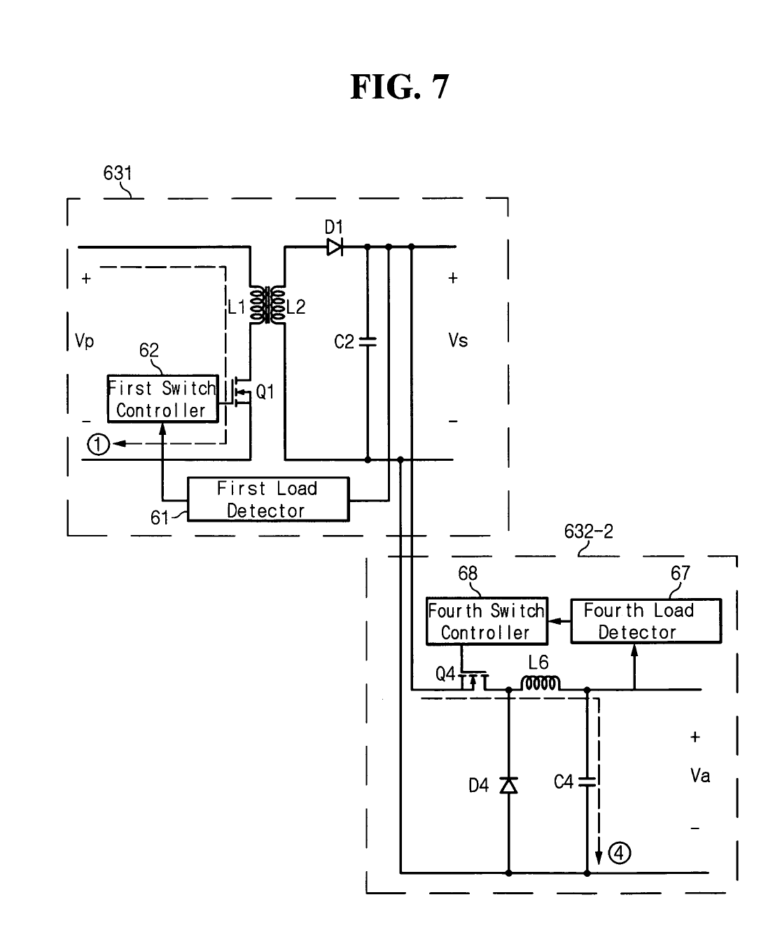

FIG. 7 is a view of a voltage generator unit according to a third exemplary embodiment of the present invention.

As shown in FIG. 7, the voltage generator unit according to the third exemplary embodiment of the present invention corresponds to the voltage generator unit according to the first exemplary embodiment of the present invention except for the configuration of the Va voltage generator.

The Va voltage generator 632-2 according to the third exemplary embodiment of the present invention includes a switch Q4, a diode D4, an inductor L6, a capacitor C4, a fourth load detector 67, and a fourth switch controller 68.

A drain terminal of the switch Q4 is connected to an output terminal of the Vs voltage generator 631, and a source terminal of the switch Q4 is connected to a node of a cathode of the diode D4 and the inductor L6. Also, a gate terminal of the switch Q4 is connected to an output terminal of the fourth switch controller 68. An anode of the diode D4 is connected to the node. A first terminal of the capacitor C4 is connected to a second terminal of the inductor L6 and a second terminal thereof is grounded. The fourth load detector 67 is connected to the output terminal of the Va voltage generator 632-2 and outputs information corresponding to the voltage Va to the fourth switch controller 68.

When the switch Q4 is turned on, the output voltage Vs of the Vs voltage generator 631 is input to the Va voltage generator 632-2, and the current path of \textcircled{4} is formed in FIG. 6. The capacitor C4 is charged with the voltage according to the path \textcircled{4}. In this instance, the voltage charged in the capacitor C4 is variable according to the on/off time (duty cycle) of the switch Q4, and hence the voltage Va is determined by the on/off operation of the switch Q4.

The fourth load detector 67 detects an output voltage of the output terminal of the Va voltage generator 632-2 and outputs the output voltage to the fourth switch controller 68. The fourth switch controller 68 compares a fourth output voltage detected by the fourth load detector 67 and a fourth reference voltage. When the fourth output voltage is greater than the fourth reference voltage, the fourth switch controller 68 increases the on time of the switch Q4. The time in which the current is supplied to the capacitor C4 is decreased to thus increase the output voltage of Va of the Va voltage generator 632-2. On the contrary, when the fourth output voltage detected by the fourth load detector 67 is less than the fourth reference voltage, the fourth switch controller 68 decreases the on time of the switch Q4. The time in which the current is supplied to the capacitor C4 is decreased to thus decrease the output voltage Va of the Va voltage generator 632-2. Accordingly, the fourth switch controller 68 controls the on/off time (duty cycle) of the switch Q4 according to the fourth output voltage of the output terminal to thus maintain the output voltage of the Va voltage generator 632-2 at the constant voltage Va.

According to the third exemplary embodiment of the present invention, the Va voltage generator 632-2 can use components with lower voltage ratings by using the output voltage Vs of the Vs voltage generator 631 as an input voltage of the Va voltage generator 632-2, and also reduces the cost by using components with lower voltage ratings. Furthermore, the Va voltage generator 632-2 according to the third exemplary embodiment of the present invention can reduce the number of components by using the inductor L6 rather than the transformer Tx.

The Va voltage generator according to the exemplary embodiments of the present invention is not restricted to the DC-DC converters of FIGS. 5 to 7, and other types of DC-DC converters for converting the input voltage Vs to the voltage Va are usable. Also, the DC-DC converter for receiving the output voltage of the Vs voltage generator as the input voltage of the Va voltage generator has been described in the exemplary embodiments of the present invention, and the voltage generator can generate other voltages. However, when the output voltage of the first voltage generator is input as an input voltage of the second voltage generator, the first voltage must be greater than the second voltage. While the present invention has been described in connection with what is presently considered to be practical exemplary embodiments, it is to be understood that the present invention is not limited to the disclosed embodiments, but, on the contrary, is intended to cover various modifications and equivalent arrangements included within the spirit and scope of the appended claims.

As described above, components with lower voltage ratings can be used for the Va voltage generating component by converting the DC voltage output by the power factor correction unit into the voltage Vs and converting the voltage Vs that is less than the output voltage of the power factor correction unit into the voltage Va. Also, the cost of the plasma display can be reduced by using components with lower voltage ratings.

What is claimed is:

1. A power supply comprising:
a power factor correction unit to correct a power factor of an input AC voltage and to output a DC voltage; and
a voltage generator unit including a first voltage generator having an input terminal connected to an output terminal of the power factor correction unit, the first voltage generator converting the DC voltage into a first voltage less than the DC voltage, and a second voltage generator having an input terminal connected to an output terminal of the first voltage generator, the second voltage generator converting the first voltage into a second voltage less than the first voltage.

2. The power supply of claim 1, wherein the first voltage generator comprises:
a first transformer including a primary coil having a first terminal connected to the output terminal of the power factor correction unit and a secondary coil to output a voltage related to a voltage of the primary coil according to a turn ratio of the first transformer;
a first switch connected to a second terminal of the primary coil;
a first diode having a first terminal connected to a first terminal of the secondary coil;
a first capacitor connected between a second terminal of the first diode and a second terminal of the secondary coil; and
a first switch controller to control a duty cycle of the first switch to maintain the voltage charged in the first capacitor at the first voltage.

3. The power supply of claim 2, wherein the first voltage generator further comprises a first load detector, connected to a node of the first diode and the first capacitor, to detect an output voltage of the first voltage generator and to output the detected output voltage to the first switch controller.

4. The power supply of claim 1, wherein the second voltage generator comprises:
a second transformer including a third coil having a first terminal connected to an output terminal of the first voltage generator and a fourth coil to output a voltage related to a voltage of the third coil according to a turn ratio of the second transformer;
a second switch connected to a second terminal of the third coil;
a second diode having a first terminal connected to a first terminal of the fourth coil;
a second capacitor connected between a second terminal of the second diode and a second terminal of the fourth coil; and
a second switch controller for controlling a duty cycle of the second switch to maintain the voltage charged in the second capacitor at the second voltage.

5. The power supply of claim 4, wherein the second voltage generator further comprises a second load detector, connected to a node of the second diode and the second capacitor, to detect an output voltage of the second voltage generator and to output the detected output voltage of the second voltage generator to the second switch controller.

6. The power supply of claim 1, wherein the second voltage generator comprises:
a first inductor having a first terminal connected to the output terminal of the first voltage generator;
a third switch connected to a second terminal of the inductor;
a third diode having a first terminal connected to the second terminal of the inductor;
a third capacitor connected between a second terminal of the third diode and the third switch;
a third load detector, connected to a node of the third diode and the third capacitor, to detecting an output voltage of the second voltage generator; and
a third switch controller to compare an output voltage detected by the third load detector and a predetermined reference voltage, and to controlling a duty cycle of the third switch to maintain the voltage charged in the third capacitor at the second voltage.

7. The power supply of claim 1, wherein the second voltage generator comprises:
a fourth switch having a first terminal connected to the output terminal of the first voltage generator;
a second inductor having a first terminal connected to a second terminal of the fourth switch;
a fourth capacitor connected to a second terminal of the second inductor;
a fourth load detector, connected to a node of the second inductor and the fourth capacitor, to detect an output voltage of the second voltage generator; and
a fourth switch controller to compare an output voltage detected by the fourth load detector and a predetermined reference voltage, and to controlling a duty cycle of the fourth switch to maintain the voltage charged in the fourth capacitor at the second voltage.

8. The power supply of claim 1, wherein the voltage generator unit further comprises a third voltage generator having an input terminal connected to an output terminal of the power factor correction unit, the third voltage generator converting the DC voltage into a third voltage less than the DC voltage.

9. A plasma display comprising:
a Plasma Display Panel (PDP) including a first electrode, a second electrode, and a third electrode crossing the first and second electrodes;
a driver to drive the PDP; and
a power unit to supply a plurality of voltages to the driver, the power unit including:
a power factor correction unit to correct a power factor of an input AC voltage and to output a DC voltage;
a first voltage generator having an input terminal connected to an output terminal of the power factor correction unit, the first voltage generator converting the DC voltage into a first voltage supplied to one of the first and second electrodes of the PDP during a sustain period of the PDP; and
a second voltage generator having an input terminal connected to an output terminal of the first voltage generator, the second voltage generator converting the first voltage into a second voltage less than the first voltage, the second voltage generator supplying the second voltage to the third electrode of the PDP during an address period of the PDP.

10. The plasma display of claim 9, wherein the first voltage generator includes:
a first transformer including a primary coil having a first terminal connected to an output terminal of the power factor correction unit and a secondary coil to output a voltage related to the voltage of the primary coil according to a turn ratio of the first transformer;
a first switch connected to a second terminal of the primary coil;
a first diode having a first terminal connected a first terminal of the secondary coil;
a first capacitor connected between a second terminal of the first diode and a second terminal of the secondary coil; and
a first switch controller to control a duty cycle of the first switch to maintain a voltage charged in the first capacitor at the first voltage.

11. The plasma display of claim 10, wherein the first voltage generator further comprises a first load detector, connected to a node of the first diode and the first capacitor, to detect an output voltage of the first voltage generator and to output the detected output voltage to the first switch controller.

12. The plasma display of claim 9, wherein the second voltage generator comprises:
a fourth switch having a first terminal connected to the output terminal of the first voltage generator;
a second inductor having a first terminal connected to a second terminal of the fourth switch;
a fourth capacitor connected to a second terminal of the second inductor;
a fourth load detector, connected to a node of the second inductor and the fourth capacitor, to detect an output voltage of the second voltage generator; and
a fourth switch controller to compare an output voltage detected by the fourth load detector and a predetermined reference voltage, and to controlling a duty cycle of the fourth switch to maintain the voltage charged in the fourth capacitor at the second voltage.

13. The plasma display of claim 12, wherein
the second voltage generator further includes
a second load detector, connected to a node of the second diode and the second capacitor, for detecting an output voltage of the second voltage generator and outputting the output voltage to the second switch controller.

14. The plasma display of claim 9, wherein the second voltage generator comprises:
a first inductor having a first terminal connected to the output terminal of the first voltage generator;
a third switch connected to a second terminal of the inductor;
a third diode having a first terminal connected to the second terminal of the inductor;
a third capacitor connected between a second terminal of the third diode and the third switch;
a third load detector, connected to a node of the third diode and the third capacitor, to detecting an output voltage of the second voltage generator; and
a third switch controller to compare an output voltage detected by the third load detector and a predetermined reference voltage, and to controlling a duty cycle of the third switch to maintain the voltage charged in the third capacitor at the second voltage.

15. The plasma display of claim 9, wherein the second voltage generator comprises:
a fourth switch having a first terminal connected to the output terminal of the first voltage generator;
a second inductor having a first terminal connected to a second terminal of the fourth switch;
a fourth capacitor connected to a second terminal of the second inductor;
a fourth load detector, connected to a node of the second inductor and the fourth capacitor, to detect an output voltage of the second voltage generator; and
a fourth switch controller to compare an output voltage detected by the fourth load detector and a predetermined reference voltage, and to controlling a duty cycle of the fourth switch to maintain the voltage charged in the fourth capacitor at the second voltage.

16. The plasma display of claim 9, wherein the voltage generator unit further comprises a third voltage generator having an input terminal connected to an output terminal of the power factor correction unit, the third voltage generator converting the DC voltage into a third voltage less than the DC voltage.

17. A method of driving a plasma display including a Plasma Display Panel (PDP) including a first electrode and a second electrode extending in a direction crossing the first electrode, a power factor correction unit to correct a power factor of an input AC voltage and to output a DC voltage and a voltage generator unit to convert the DC voltage into a plurality of voltages to drive the plasma display, the method comprising:
converting the DC voltage into a first voltage less than the DC voltage;
converting the first voltage into a second voltage less than the first voltage; and
supplying the first voltage and the second voltage to the plasma display;
wherein the first voltage is supplied to the first electrode for a sustain discharge and the second voltage is supplied to the second electrode for an address discharge.

18. The method of claim 17, further comprising:
converting the DC voltage into a third voltage less than the first voltage; and
supplying the third voltage to the plasma display.
